(19) United States
(12) Patent Application Publication
(10) Pub. No.: US 2023/0152347 A1
(43) Pub. Date: May 18, 2023

(54) SYSTEMS AND METHODS FOR COMPUTING CALIBRATION PARAMETERS FROM AMBIENT SENSING

(71) Applicant: MYTI, Inc., Boca Raton, FL (US)

(72) Inventor: Michael Janusz WOODS, Mountain View, CA (US)

(21) Appl. No.: 17/990,503

(22) Filed: Nov. 18, 2022

Related U.S. Application Data
(60) Provisional application No. 63/361,053, filed on Nov. 18, 2021.

(51) Int. Cl. G01P 21/00; G01P 1/00

(52) U.S. Cl. CPC G01P 21/00; G01P 1/06

(57) ABSTRACT

Various embodiments are directed to improvements to sensor calibration systems, methods, and configurations. Subject system improvements and configurations facilitate the manufacturing process of such sensors, and of devices containing such sensors, to be dramatically simplified, reducing or eliminating the need for costly, dedicated calibration steps directly in the manufacturing process. Such configurations have application and relevance in the design and manufacture of such sensors requiring calibration, as well as in the design and manufacture of larger devices containing such sensors requiring calibration as subcomponent(s), with direct impacts to many market segments, including, without limitation, visualization systems of various types, autonomous vehicles, and security systems and the like.

### CROSS-REFERENCE TO RELATED APPLICATIONS

This application claims benefit of U.S. Provisional application No. 63/361,053, filed Nov. 18, 2021, the contents of which are incorporated herein by reference in their entirety.

### FIELD OF THE INVENTION

This set of inventions relates generally to the field of sensor calibration, and more specifically to new and useful improvements in the design of systems that implement sensor calibration procedures to enable such systems to produce calibration parameters directly from ambient, or “real world” data, and to reduce or eliminate the reliance of such systems on carefully controlled and/or automated, robotic, or fixed fixtures with known ground truth in, e.g., a factory setting or otherwise. These system improvements enable the manufacturing process of such sensors, and of devices containing such sensors, to be dramatically simplified, reducing or eliminating the need for costly, dedicated calibration steps directly in the manufacturing process. This has applications in the design and manufacture of such sensors requiring calibration, as well as in the design and manufacture of larger devices containing such sensors requiring calibration as subcomponent(s), with direct impacts to many market segments, including, without limitation, visualization systems, augmented reality, virtual reality, autonomous vehicles, security systems, etc.

### BACKGROUND

In current practice, many sensors are manufactured in such a way as to require some form of calibration before they may be used to collect accurate data. Such a calibration typically produces some mathematical relationship, or parameters used to define a mathematical relationship, which is used to modify the “raw data” collected by the sensor in order to produce the “corrected data”, with the intent that the corrected data be a more accurate representation of the system being observed by the sensor than the raw data is.

Without loss of generality, we will refer to the mathematical model, or parameters used to define such a model, as the “calibration parameters”.

When such calibration parameters are used only to modify the data of a single, particular sensor, those calibration parameters are termed “intrinsic calibration parameters”, and the process that produces them is termed “intrinsic calibration”. For example, in optical sensors, intrinsic calibration parameters might include data related to the precise focal length of the sensor, or to the location of the principal point of the sensor. For further example, in accelerometer sensors, intrinsic calibration parameters might include data related to the precise angle between the axes of measurement (e.g., X-axis, Y-axis, Z-axis).

In larger devices, one or more sensors may be incorporated alongside zero or more components in such a way that the correct functioning of the larger device relies on a precise determination of the relative position and/or orientation of the sensor(s) and other component(s). The relative position and/or orientation of two components, sensors or otherwise, is termed the “extrinsic relationship” between those components. The precise data representing this relationship is termed the “extrinsic calibration parameters” between those components. And the process by which this data is obtained is termed the “extrinsic calibration process”.

In particular, without loss of generality, augmented reality systems especially (but other systems as well) may include other classes of components that require intrinsic and/or extrinsic calibration, but are not traditionally thought of as “sensors” because they do not directly produce a measurement of some system. For example, see-through displays may require intrinsic and/or extrinsic calibration so that images displayed using them may appear to the user of the augmented reality system to be correctly aligned with real world features. In the descriptions herein, the calibration of such devices is automatically included and referred to within the categories of “sensor” and/or “sensor calibration” (especially by virtue of the, e.g., display and user's eye, forming a compound sensor capable of detecting the alignment of the displayed images with respect to features in the real world).

In typical practice, extensive effort is required to produce intrinsic and/or extrinsic calibration parameters for sensors and systems and/or devices incorporating such sensors to operate correctly and accurately. Such efforts may include, but are not limited to, the development and use of robotic systems, the development and use of artifacts with precisely crafted features (termed “fiducials”), the development and use of precisely measured and/or controlled environments, and/or the development and use of precision metrology equipment. As non-limiting examples, optical sensors may be calibrated by the use of a known, precision-crafted visual pattern, such as checkerboards and/or aruco markers; and inertial measurement units may be calibrated by the use of rate tables, which spin the sensor at a known rate and at a fixed distance from an axis of rotation.

The goal of these calibration systems is generally to have some form of physically observable environment with known observable parameters, such that when the sensor and/or device undergoing calibration is used to observe the environment, the raw data produced by the sensor and/or device can be compared to the known observable parameters, and the difference between the raw data and the known observable parameters can be used to determine the necessary intrinsic and/or extrinsic calibration parameters for the correct function of the sensor and/or device.

Since it is advantageous to be able to produce sensors and/or devices incorporating them as cheaply and efficiently as possible, it is clear that it would be desirable to develop a system that implements a process for determining the relevant intrinsic and/or extrinsic calibration parameters on the basis of the collection and analysis of “ambient data”, or data collected from environments that are not precisely controlled, measured, or otherwise known. Such a system would allow manufacturers of such sensors and/or devices to simplify their manufacturing process greatly, and reduce and/or eliminate their reliance on calibration systems involving precisely controlled, measured, or otherwise known data.

### BRIEF DESCRIPTION OF THE DRAWINGS:

FIG. 1A illustrates a device configuration with a sensor operatively coupled to a compute unit.

FIG. 1B illustrates a configuration comprising two devices, with a sensor operatively coupled to a compute unit through a communications channel.

FIG. 2 illustrates a system configuration wherein observation information from an uncontrolled environment is utilized as an input to a sensor and intercoupled compute unit configuration.

FIG. 3 illustrates a system configuration wherein observation information from an uncontrolled environment is utilized as an input to sensor that is operatively coupled with a compute unit configured for data processing and threshold analysis.

FIG. 4 illustrates a system configuration wherein observation information from an uncontrolled environment is utilized as an input to sensor configuration that is operatively coupled with a compute unit.

FIG. 5 illustrates a system configuration wherein observation information from an uncontrolled environment is utilized as an input to sensor configuration that is operatively coupled with a compute unit.

FIG. 6 illustrates aspects of a logical flow configuration wherein a compute unit may be utilized to produce final calibration parameters, or to determine a next sensor to collect data from, and to request data from such sensor.

FIGS. 7A and 7B illustrate various aspects of sensor and compute unit distribution configurations in accordance with the present invention.

FIG. 8 illustrates aspects of a logical flow configuration wherein a compute unit may be utilized to produce final calibration parameters, or to determine a next sensor to compute calibration for, and to compute calibration parameters for such next sensor.

FIG. 9 illustrates a system configuration wherein observation information from an uncontrolled environment is utilized as an input to sensor configuration that is operatively coupled with a compute unit.

### DETAILED DESCRIPTION

This application claims priority to U.S. Provisional Patent Application Ser. No. 63/361,053 and filed on Nov. 18, 2021, which is incorporated by reference herein in its entirety.

The following description of the preferred embodiments of the invention is not intended to limit the invention to these preferred embodiments, but rather to enable any person skilled in the art to make and use this invention. All specific descriptions herewith should be considered particular, non-limiting, examples of the general principles invented, described, and claimed here.

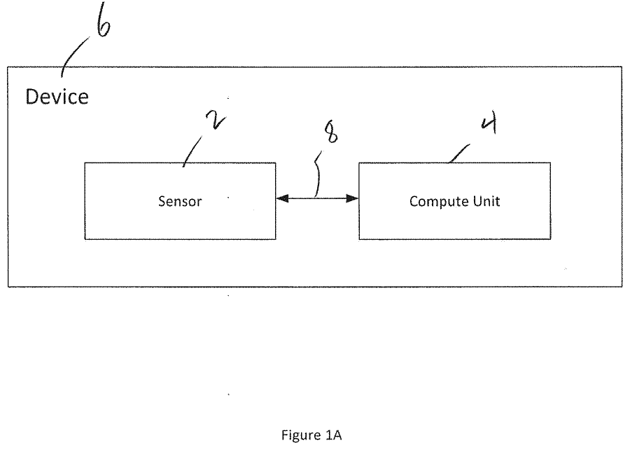

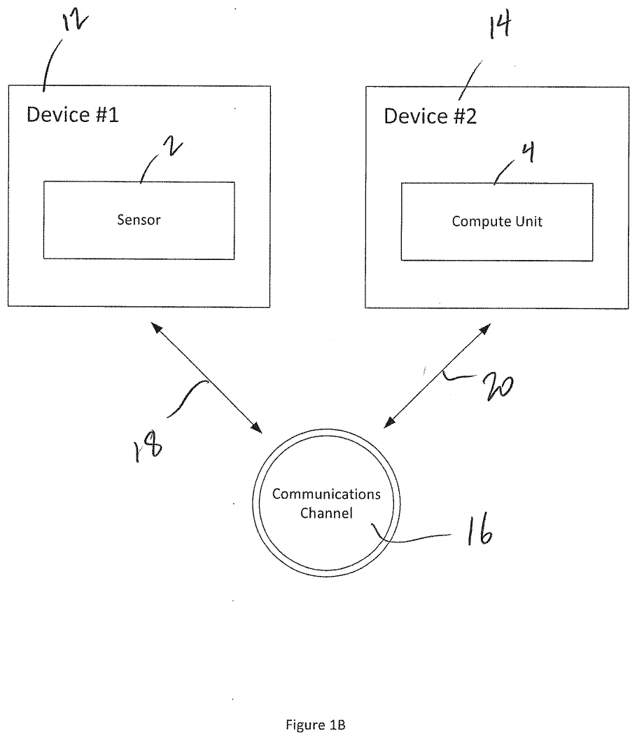

A first group of embodiments (pertaining to FIGS. 1A, 1B, 2, 3, 4, and 5) pertains to systems configured to implement processes for obtaining intrinsic calibration parameters for one or more sensors on the basis of collection of ambient data (such as that associated with an uncontrolled emvironment) and processing of that data by a compute unit:

In these embodiments, one may consider a simple case of a single sensor for which intrinsic calibration parameters are desired.

In such a case, a system may comprise a sensor and a compute unit. The sensor and compute unit may be physically integrated into a single device, as in the configuration of FIG. 1A wherein a device (6) comprises a sensor (2) operatively coupled (8), such as via electronic lead or wireless connectivity, to a compute unit (4). FIG. 1B illustrates a configuration wherein a sensor (2) and a compute unit (4) may be physically separate, coupled to two different devices (12, 14), but operatively coupled (18, 20), such as via electronic lead or wireless connectivity, to be able to send data back and forth over a communications channel (16), such as the internet or associated networking configuration.

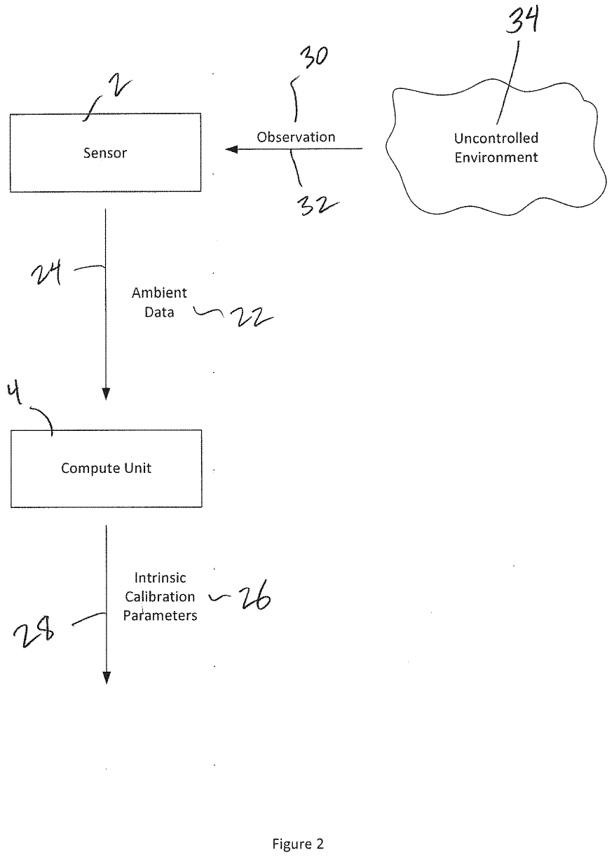

In such basic configurations, the system may be configured to implement a process whereby the sensor captures some amount of ambient data, transmits that data to the compute unit, the compute unit processes that data by some algorithm, and then the compute unit generates intrinsic calibration parameters for the sensor on the basis of the processed data. For example, referring to FIG. 2, a basic data flow is illustrated wherein observation information (30) from an uncontrolled environment (34) may be communicated (32), such as via wired or wireless coupling, to a sensor (2) which may be configured to produce ambient data (22) and communicate (24) such data, such as via wired or wireless operative coupling, to the compute unit (4) to create and output (28) intrinsic calibration parameters (26).

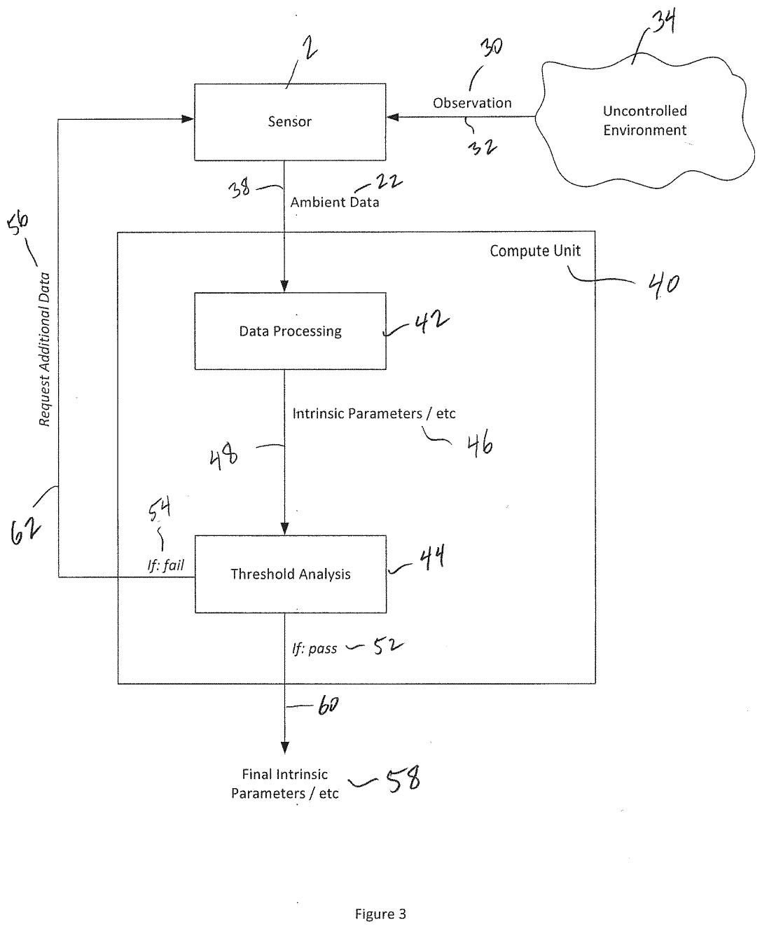

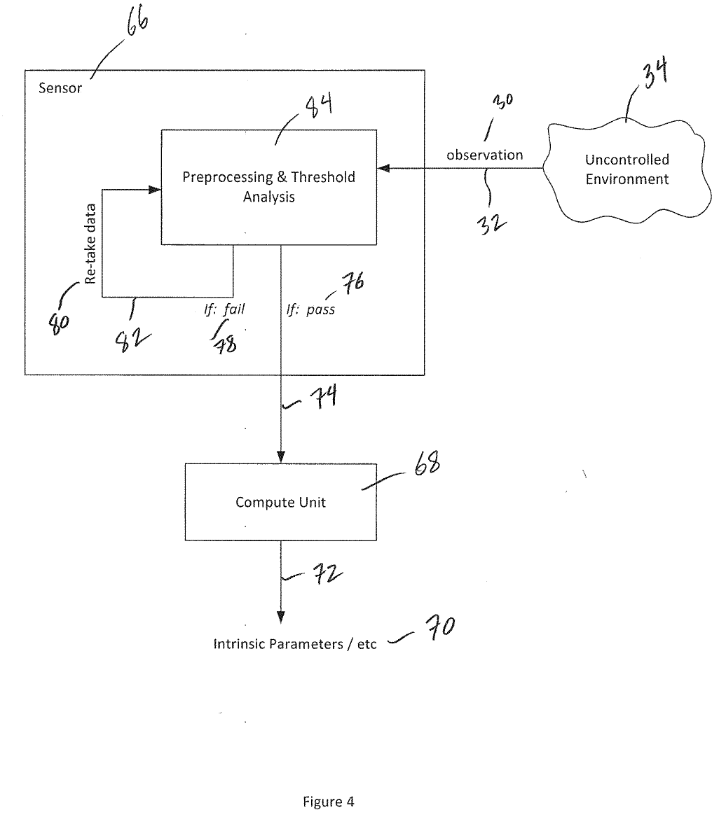

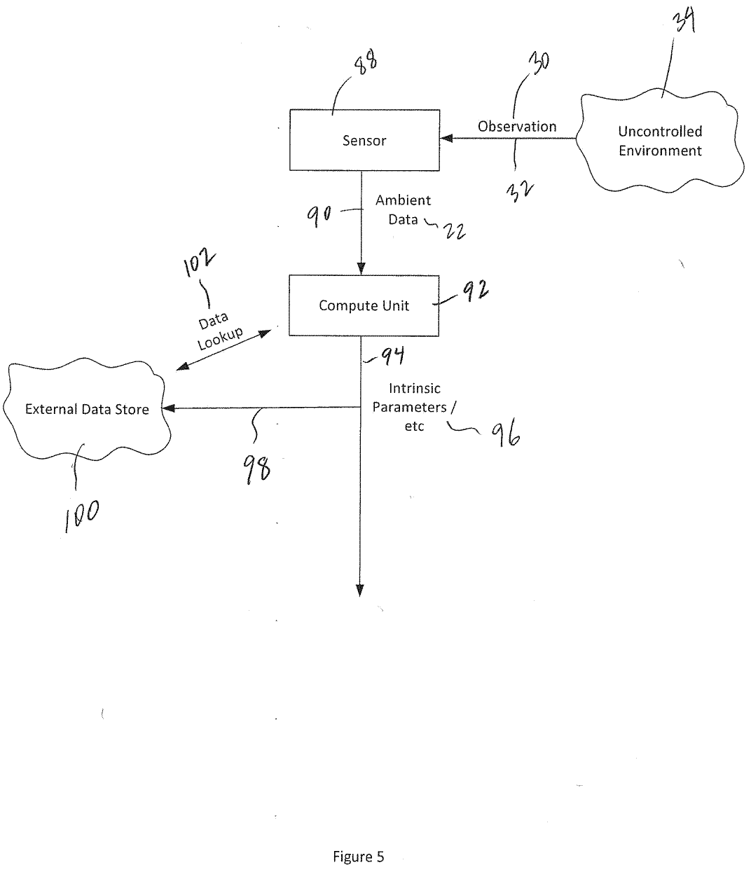

The performance of such a system configuration may be enhanced by a variety of alternative configurations which may be included in the embodiment in some combination (or none at all), as follows:
1. A sensor's collection of the ambient data may be triggered by the compute unit. Such triggering process may be conducted in accordance with a preset clock or schedule, or in response to some other event (e.g., first device turn-on, a manufacturing step, an error detection process, user request, etc).
2. A sensor may be configured to return not just a single set of ambient data, but may also return directly (or a reference to) historically collected data by the same sensor.
3. A sensor may return not just a single set of ambient data, but may also return (either directly or by reference) information related to sensor uncertainties. As a non-limiting example, an optical sensor may close its shutter and capture a “dark image” encompassing only zero-level noise; such “dark image” may be transmitted to the compute unit alongside the ambient data.
4. A sensor may be configured to return not just a single set of ambient data, but also to return (either directly, or by reference) data from any other associated sensors. As a non-limiting example, an Inertial Measurement Unit (“IMU”) may be physically placed local to a temperature sensor; the IMU may, in such case, be configured to query the temperature sensor for a reading, and then package that data alongside its own ambient data collection for transmission together to the compute unit.
5. The compute unit may be configured to return not just intrinsic calibration parameters, but also to return (either directly, or by reference) information regarding the uncertainties associated with the generated intrinsic calibration parameters.
6. The compute unit may be configured to perform a partial computation on the first set of ambient data, and then to trigger the sensor to collect additional ambient data, such that the compute unit may produce intrinsic calibration parameters only once all necessary ambient data has been collected.
7. A system may be configured as in item #6 of this first group of embodiments outline above, but with the compute unit configured to produce intermediate results before the full set of ambient data has been collected.
8. A system may be configured as in item #6-7 of this first group of embodiments outline above, but the intermediate results of the compute unit being configured as part of a control loop, such that either or both of the intrinsic parameters and their associated uncertainties may be analyzed according to some threshold to determine a dynamic stop to the ambient data collection once the intrinsic parameters and/or their associated uncertainties have passed the threshold. Referring to FIG. 3, a system data flow diagram is illustrated wherein observation information (30) pertaining to an uncontrolled environment (34) may be communicated (32) to a sensor (2), such as via wired or wireless communications configuration. The sensor (2) may be configured to output ambient data (22), which may be communicated (32), such as via wired or wireless operative coupling, to a compute unit (40) which may comprise a data processing module (42) configured to determine intrinsic parameters/etc (46) based upon the ambient data (22), and to communicate (48), such as by wired or wireless operative coupling, these parameters (46) for threshold analysis (44). Should the parameters (46) logically pass (52) the threshold analysis (44), they may be communicated (60), such as by wired or wireless operative coupling, out of the compute unit (40) as final intrinsic parameters/etc (58). Should the parameters (46) logically fail (54), a control loop (62), featuring operative coupling such as wired or wireless intercoupling, may be utilized to collect or request additional ambient data (56).
9. A system may be configured as in item #6-8 of this first group of embodiments outline above, but the data collection requests may be sent by the compute unit to the sensor may include parameters intended to control the operation of the sensor while collecting the ambient data. As a non-limiting example, for an optical sensor, this information might include specified exposure time lengths. This control information may be fixed, or may be dynamically determined on the basis of a pre-set pattern, or on any intermediate result of the process.
10. A sensor may implement some form of pre-processing on its ambient data collection, to ensure it returns only suitable ambient data. For example, without limitation, this may involve the sensor collecting ambient data and processing it to compare it against some sort of threshold, and only passing data to the compute unit once the sensor has collected ambient data that passes the threshold. As a non-limiting example, an optical sensor may examine total image brightness, and only return data to the compute unit once it has collected an image with total brightness above a minimum threshold and/or below a maximum threshold. Referring to FIG. 4, a system data flow embodiment is illustrated wherein observation information (30) pertaining to an uncontrolled environment (34) may be communicated (32) to a sensor (66), such as via wired or wireless communications configuration. The sensor (66) may be configured to utilize pre-processing and threshold analysis (84) to generate a control loop for producing ambient data passing thresholding requirements, such that if a logical pass based on the thresholding is determined (76), an output is delivered (74), such as via wired or wireless operative coupling, to the compute unit (68) and may be output (72), such as via wired or wireless communication configuration, as intrinsic parameters/etc (70). Should a logical fail (78) based upon the thresholding analysis be determined, a communication, such as via wired or wireless operative coupling (82), may initiate a re-take of data (80) and another cycle.
11. A system may be configured as in item #10 of this first group of embodiments outline above, but the sensor, failing to collect data that passes the threshold, may be configured to return an error message to the compute unit such that that error message might trigger any (or multiple) of a variety of response, including without limitation: instituting a delay before retry of process, sending a message to the user, logging a message in system log, etc.
12. A sensor and a compute unit may be physically connected together, within a single device.
13. A sensor and a compute unit may be physically connected together, across multiple discrete devices (e.g., with a USB cable, etc).
14. A sensor and a compute unit may be not physically connected together, but instead operatively coupled such that they coordinate their actions by transmitting data over some sort of communications channel (e.g., over a wired or wireless connection, over the internet, etc, as noted above).
15. The method by which the compute unit processes the ambient data from the sensor in order to produce the intrinsic calibration parameters may be by an algorithm, represented either in hardware or software, and may be permanently loaded onto the compute unit, may be dynamically updateable, may be obtained by reference from an external source, may be accessed at an external source through a known or predetermined application programming interface (“API”), etc. As a non-limiting example, one embodiment may comprise query of a deep neural network hosted on an external server and accessed by a web API, such that the deep neural network in question may have been trained and validated on the intrinsic calibration task through the use of known sensors and controlled environments, but which is nonetheless able to produce intrinsic calibration parameters from ambient data collected from uncontrolled environments.
16. A system may be configured as in item #15 of this first group of embodiments outline above, but the configuration by which the compute unit processes the ambient data from the sensor may be configured to incorporate data pertaining to the sensor's specific kind, date of manufacture, capabilities, etc. Without limitation, such information may be included by: first—the sensor may be configured to send some form of serial number alongside the ambient data to the compute unit; second—the compute unit may be configured to access the necessary information either from its direct memory or by lookup in some form of (possibly external) database.
17. A system may be configured as in items #15-16 of this first group of embodiments outline above, but the data store and lookup may be configured to include information pertaining to the intrinsic calibration parameters (and/or ambient data, intermediate computation results, associated uncertainties, sensor serial number, etc) produced by the operation of such a system and process on other sensors similar to the particular sensor under examination. As a non-limiting example, if a family of sensors produced in a certain manufacturing batch is generally found to have intrinsic calibration parameters close to a certain value, then that value may be stored in the data store, and used as an additional input to the calibration of any particular sensor.
18. A system may be configured as in items #15-17 of this first group of embodiments outline above, but the resulting intrinsic calibration parameters produced by the calibration process on the particular sensor under examination (and/or the raw ambient data, intermediate computation results, associated uncertainties, sensor serial number, etc) may be added to the data store for future access, analysis, lookup, and/or incorporation into a future calibration and/or processing step on this, or another, sensor. For example, referring to FIG. 5, a system configuration is illustrated wherein observation information (30) pertaining to an uncontrolled environment (34) may be communicated (32) to a sensor (88), such as via wired or wireless communications configuration. The sensor (88) may be configured to output ambient data (22), which may be communicated (90), such as via wired or wireless operative coupling, to a compute unit (92) which may be configured to output (94), such as via wired or wireless operative coupling, intrinsic parameters/etc (96) which may be uploaded (98), such as via wired or wireless communication link, to an external data storage system (100); the compute unit (92) may be configured to have lookup connectivity (102), such as via wired or wireless communications link, with the external data store (100).
19. A system may be configured such that resulting intrinsic calibration parameters produced by the calibration process may be sent back to the particular sensor being calibrated to be included into an onboard “pre-processing” step executed either automatically, or as controlled by a parameter, whenever that particular sensor is requested to capture and return data for any purpose in the future.

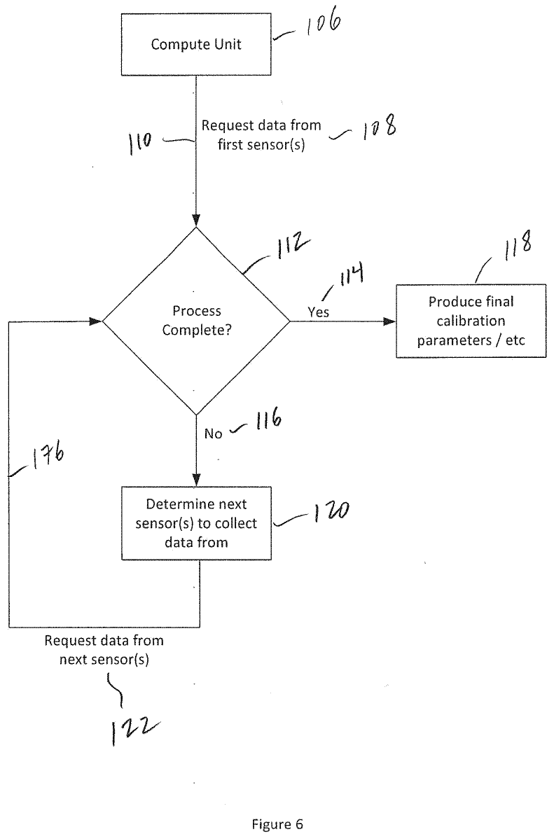

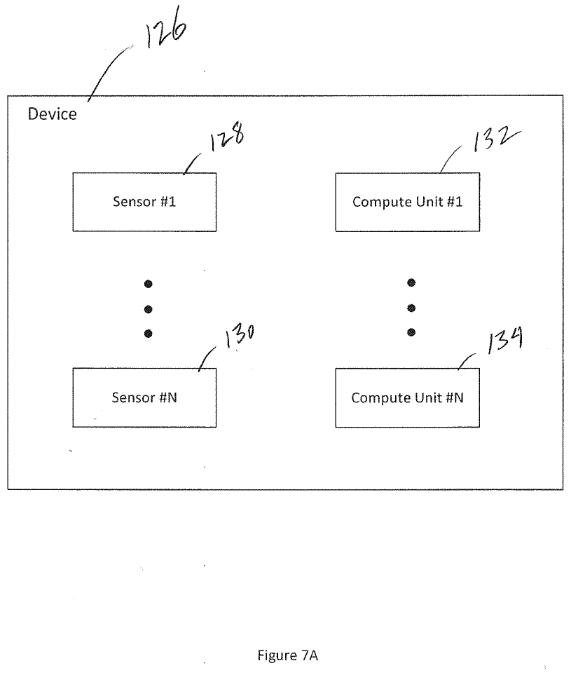

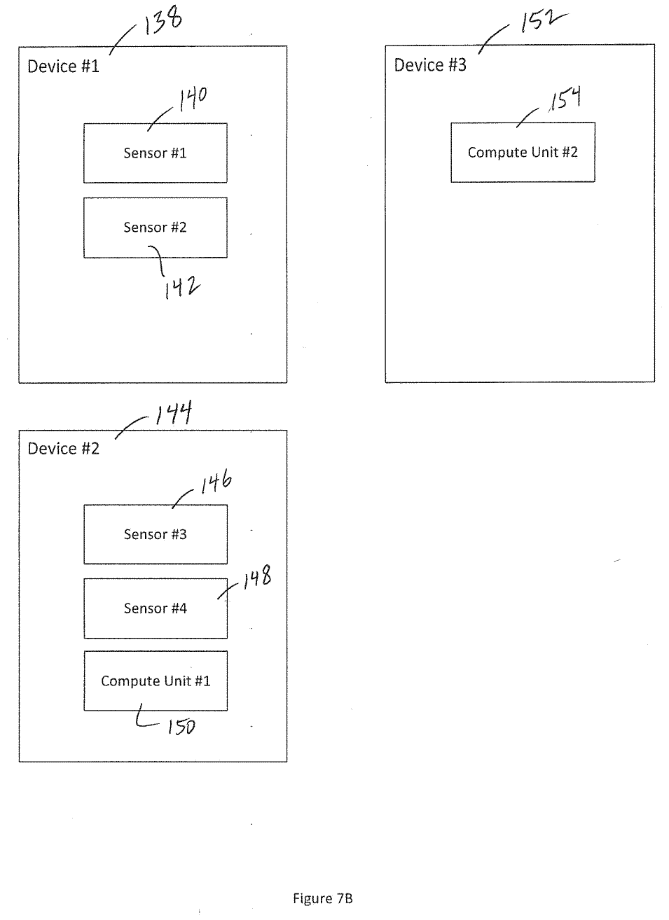

Second group of embodiments (pertaining to FIGS. 6, 7A, and 7B)—system configurations that implement processes for obtaining intrinsic calibration parameters for a plurality of sensors of the same, or different, modalities on the basis of collection of ambient data (such as pertaining to an uncontrolled environment) and processing of such data by a compute unit:

In this second group of embodiments, we expand upon the scope of the embodiments described in the above outline of the first group of embodiments. Therefore, we incorporate by reference the totality of the aforementioned first group of embodiments, and here will detail a variety of potential enhancements and/or modifications to various system configurations with the focus on the presence of a plurality of sensors. These following configurations may be included in such embodiments in various combinations (or none at all):
1. A plurality of sensors pertaining to a subject system may be limited to those of a particular modality (e.g., all optical sensors), may be unlimited across modalities, or may be limited by some other specified constraint (e.g., 2 optical sensors for each inertial measurement unit).
2. A system may comprise one or more compute units.
3. The compute unit(s) may comprise dedicated compute resources to particular sensors, or to particular modalities of sensors; and/or the compute unit(s) may include dynamically allocatable compute resources for particular sensors or for particular modalities of sensors.
4. The compute unit(s) may be configured to request data from the sensors in parallel, or in some sequence (that may be partially parallel) such that the sequence is either predetermined, or dynamically determined.
5. This group of embodiments may comprise embodiments similar to those of item #4 of this group, but wherein dynamic determination of the data collection sequence may include in its inputs information from the sensors themselves, information from the processing of prior ambient data from the data collection sequence, and/or information from some data store, either local or remote. As a non-limiting example, the compute unit(s) may be configured to first query the serial numbers of all available sensors in order to determine which sensor(s) to collect ambient data from first, and then on the basis of the intrinsic calibration results produced, may be configured to determine which sensor(s) to collect ambient data from next.
6. This group of embodiments may comprise embodiments similar to those of items #4-5 of this group, but the data collection sequence configured to request data from some set of sensor(s) at multiple points in the data collection sequence. For example, referring to FIG. 6, a logical flow configuration is illustrated wherein a compute unit (106) may be configured to request data from first sensor(s) (108), such as via wired or wireless intercoupling. A process completion logical (112) determination may be made; if positive (114), then the system may be configured to produce final calibration parameters/etc (118); if negative (116), then the system may be configured to determine next sensor(s) to collect data from (120), and to follow a loop (176) to request data from the next sensor(s) (122) in a dynamic determination of data collection sequence configuration.
7. The method by which the compute unit processes the ambient data from any particular sensor to determine that sensor's intrinsic calibration parameters may comprise, either directly or by reference, the ambient data collected by any other sensor(s); and/or the determined intrinsic calibration parameters of any other sensor(s); and/or any intermediate computation result from any other sensor(s); and/or any other information associated with any of the sensors, whether that information is available locally or in some other accessible data store.
8. The sensor(s) and compute unit(s) may be physically integrated into a single device, or may be physically separate, integrated into multiple, disparate devices. For example, referring to FIG. 7A, a plurality of sensors (128, 130) and compute units (132, 134) may be intercoupled within the same device (126). Referring to FIG. 7B, various sensors (140, 142, 146, 148) and computing units (150, 154) may distributed across a plurality of distinct physical devices (138, 144, 152) which may be intercoupled, such as via wired or wireless communication linkages.

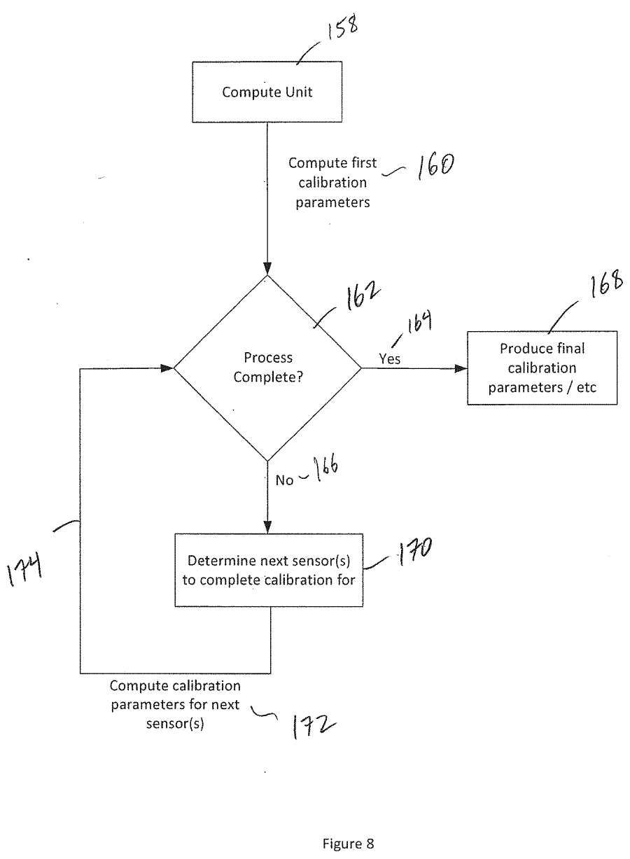

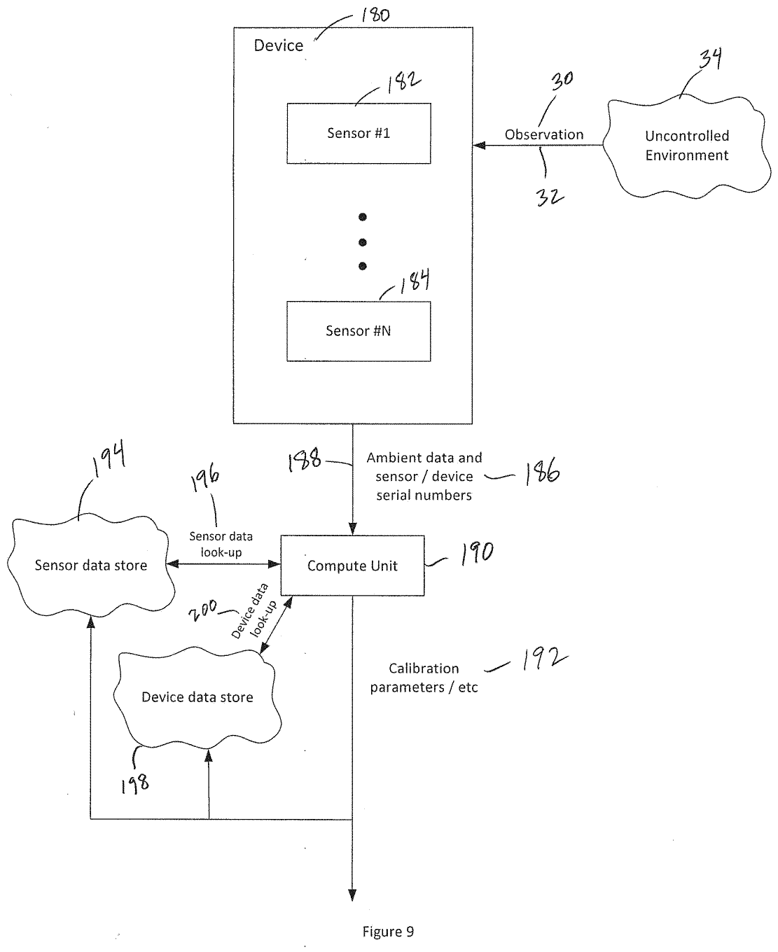

Third group of embodiments (pertaining to FIGS. 8 and 9)—system configurations that implement processes for obtaining extrinsic calibration parameters for a plurality of sensors on the basis of collection of ambient data and processing of that data by a compute unit:

In this third group of embodiments, we expand upon the scope of the first and second groups of embodiments described above. Therefore, we incorporate by reference the totality of these aforementioned embodiments, and here will detail a variety of potential enhancements and/or modifications to various system configurations with the focus on the determination of extrinsic calibration parameters. These following configurations may be included in such embodiments in various combinations (or none at all):
1. The system may be configured to determine intrinsic and/or extrinsic calibration parameters for the sensor(s) in any combination, partial or total. As a non-limiting example, only intrinsic calibration parameters may be computed for one subset of the sensors, only extrinsic calibration parameters may be computed for another subset of the sensors, and both intrinsic and extrinsic calibration parameters may be computed for a third subset.

In what follows, we will use the general term “calibration parameters” to refer to any combination of intrinsic and/or extrinsic calibration parameters, without limitation.
2. The system may be configured to determine the calibration parameters of the sensor(s) in any sequence, either preset or dynamically determined, and the system may use the intermediate results of this process to determine the remainder of the sequence. Without limitation, this sequence may also be a “one-shot” sequence, where all data is collected in parallel, and all calibration parameters are computed in parallel in a single step. For example, referring to FIG. 8, a logical system flow configuration is illustrated wherein a compute unit (158) may be configured to compute and output first calibration parameters (160). A logical process complete loop may be configured such that if affirmatively complete (164), the system is configured to produce final calibration parameters/etc (168); if not affirmatively complete (166), the system may be configured to determine a next sensor(s) to complete calibration for (170), and to continue through a loop (174) to compute calibration parameters for the next sensor(s) (172) in a dynamic determination of sequence of calibration parameter production.
3. Similar to as noted above, the system may be configured to incorporate any other associated data, either locally available or otherwise available in some form of data store, into its computation process.
4. Similar to as noted above, the system may be configured to store some, or all, of the produced calibration parameters, uncertainties thereof, intermediate results, and/or any other associate data in either local data storage or in some accessible external data store. In particular, this data storage may be associated with the individual sensor data entries and/or with the data entries corresponding to the physical device that the sensor(s) are integrated within. As a non-limited example, cameras on an aerial drone may have their calibration parameters stored in an external database and associated both with the serial numbers of the individual cameras, as well as with the serial number of the particular drone in question. For example, referring to FIG. 9, a system may be configured such that observation data (30) pertaining to an uncontrolled environment (34) is communicated (32), such as via a wired or wireless communication link, to a device (180) which may comprise a plurality (182, 184) of sensors. The sensor device (180) may be configured to output ambient data and sensor/device serial numbers (186), such as via wired or wireless communication link (188), to the compute unit (190), which may be configured to output calibration parameters/etc (192) which may be uploaded back to sensor (194) and device (198) specific data stores; such data stores (194, 198) may be operatively coupled (196, 200), such as via wired or wireless communications link, to the compute unit (190), to facilitate lookup of sensor or device specific data from the external data stores (194, 200).

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A system comprising a sensor and a computing device operatively coupled and configured to provide enhanced aspects pertaining to device calibration.
